(19) United States
(12) Patent Application Publication
(10) Pub. No.: US 2009/0095877 A1
(43) Pub. Date: Apr. 16, 2009

(54) ADJUSTABLE SUPPORTING DEVICE WITH MOVABLE TELESCOPIC LEG UNITS

(76) Inventor: Hao-Wei POO, Taipei City (TW)

Correspondence Address: LADAS & PARRY LLP, 224 SOUTH MICHIGAN AVENUE, SUITE 1600, CHICAGO, IL, 60604, US

(21) Appl. No.: 11/872,851

(22) Filed: Oct. 16, 2007

(51) Int. Cl. F16M 13/00

(52) U.S. Cl. 248/694

(57) ABSTRACT

A supporting device includes two telescopic leg units each including a vertical upper leg rod sleeved movably on a vertical lower leg rod, a mounting plate connected pivotally to a lower end of the lower leg rod, and a first positioning member operable to anchor the upper leg rod to the lower leg rod. A hollow connecting seat is mounted on upper ends of the upper leg rods of the leg units such that each leg unit is movable relative to the connecting seat in a direction perpendicular to the leg units. Two second positioning members extend respectively through the upper ends of the upper leg rods of the leg units, are slidable along a horizontal slot in the connecting seat, and are operable to anchor the leg units to the connecting seat.

### BACKGROUND OF THE INVENTION

1. Field of the Invention

The invention relates to a supporting device, more particularly to an adjustable supporting device.

2. Description of the Related Art

A conventional supporting device is used to support an electric generating apparatus on a roof that has a flat outer surface serving as a supporting surface, and has a fixed structure corresponding to the roof so as to support horizontally the electric generating apparatus. However, the conventional supporting device having the fixed structure cannot ensure that the electric generating apparatus can be supported stably on an inclined supporting surface or an uneven supporting surface.

### SUMMARY OF THE INVENTION

Therefore, the object of the present invention is to provide a supporting device that can be adjusted to be mounted stably on an inclined supporting surface.

According to the present invention, a supporting device comprises:

a pair of telescopic leg units each including
a vertical lower leg rod having opposite upper and lower ends,
a mounting plate connected pivotally to the lower end of the lower leg rod and adapted to be mounted on a supporting surface,
a vertical upper leg rod sleeved movably on the lower leg rod and having an upper end, and
a first positioning member extending through one of the upper and lower leg rods and slidable on the other one of the upper and lower leg rods, the first positioning member being operable so as to anchor the upper leg rod to the lower leg rod;

a hollow connecting seat mounted on the upper ends of the upper leg rods of the telescopic leg units such that each of the telescopic leg units is movable relative to the connecting seat in a direction perpendicular to the telescopic leg units, the connecting seat being formed with a horizontal slot therethrough; and

a pair of second positioning members each extending through the upper end of the upper leg rod of a corresponding one of the telescopic leg units and the horizontal slot in the connecting seat such that the second positioning members are slidable along the horizontal slot in the connecting seat, the second positioning members being operable so as to anchor the telescopic leg units to the connecting seat such that a desired distance is formed between the telescopic leg units.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view showing a supporting assembly including the preferred embodiment of two supporting devices according to the present invention, when used for supporting an electric generating apparatus using wind energy on a gable roof;

FIG. 2 is a fragmentary perspective view showing the supporting assembly of FIG. 1;

FIG. 3 is a partly exploded perspective view showing the preferred embodiment;

FIG. 4 is a schematic side view showing a telescopic leg unit of the preferred embodiment when in one state of use;

FIG. 5 is a schematic view showing the telescopic leg unit of the preferred embodiment when in another state of use;

FIG. 6 is a schematic view showing the preferred embodiment when in one state of use; and

FIG. 7 is a schematic view showing the preferred embodiment when in another state of use.

### DETAILED DESCRIPTION OF THE PREFERRED EMBODIMENT

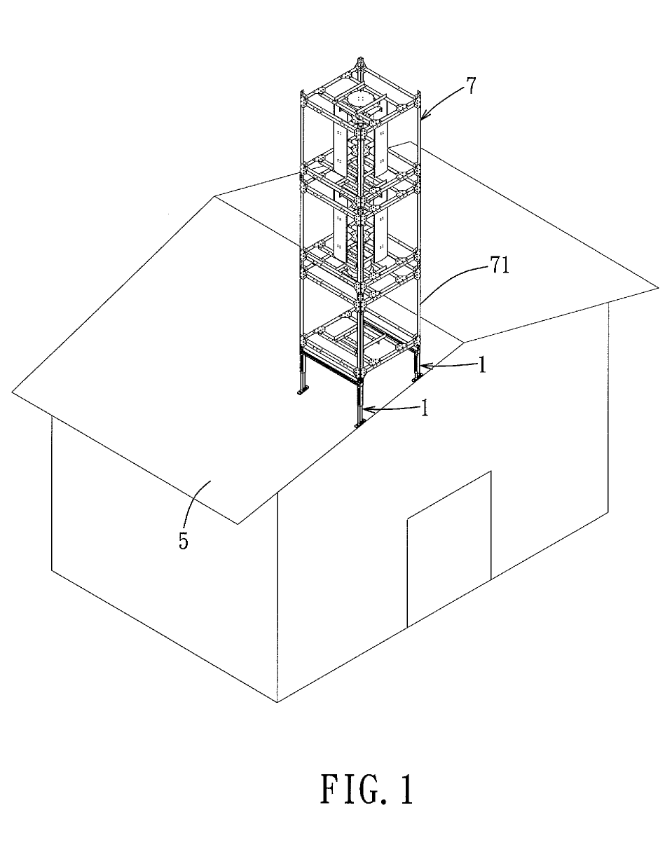

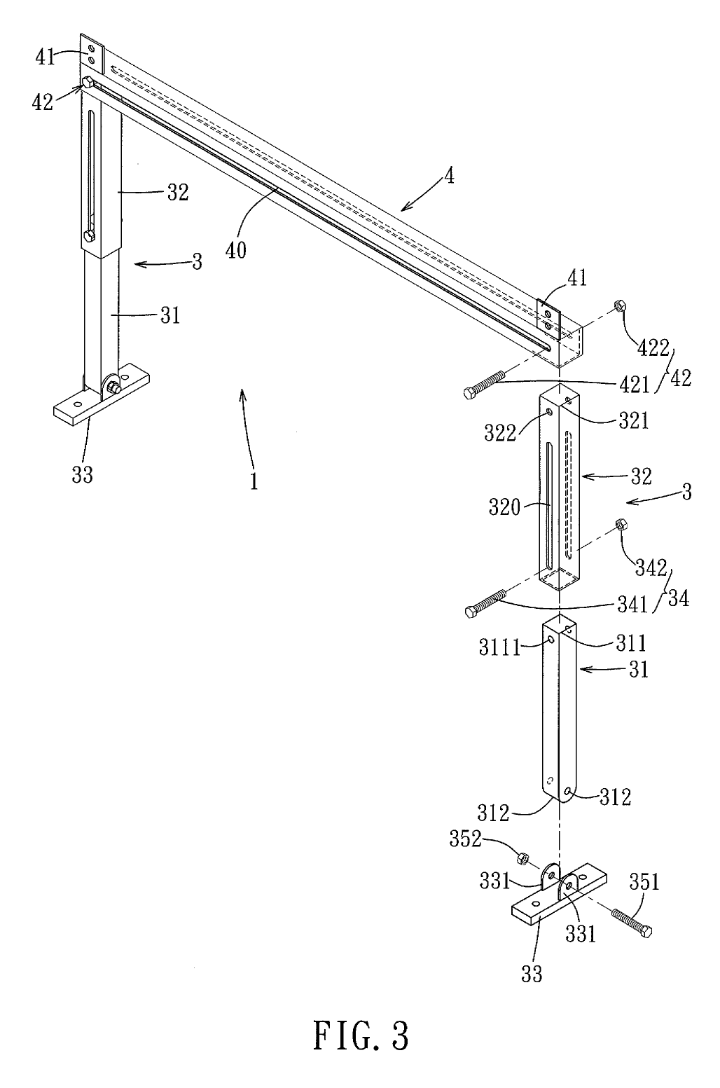

Referring to FIGS. 1 to 3, a supporting assembly including two supporting devices 1 exemplifying the present invention is shown to be adapted for supporting an electric generating apparatus 7 on a gable roof 5. In this embodiment, the electric generating apparatus 7 includes a main frame 71 having four angle bars 70 that extend downwardly from a bottom end thereof and that are disposed respectively at four corners thereof.

Each supporting device 1 includes a pair of telescopic leg units 3, a hollow connecting seat 4, and a positioning unit.

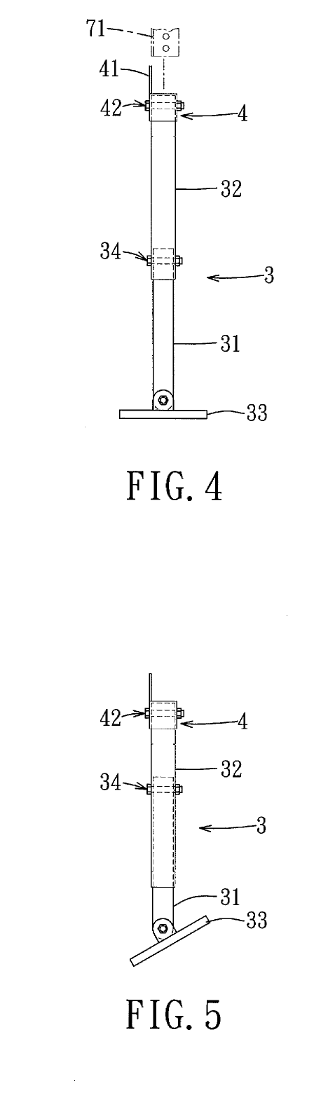

In each supporting device 1, each telescopic leg unit 3 includes a vertical lower leg rod 31, a mounting plate 33, a vertical upper leg rod 32, and a first positioning member 34. The vertical lower leg rod 31 of each telescopic leg unit 3 has opposite upper and lower ends 311, 312 formed respectively with through holes 3111, 3121 therethrough. In this embodiment, the mounting plate 33 of each telescopic leg unit 3 is adapted to be mounted on the roof 5, has opposite pivot lugs 331 extending uprightly from a top surface thereof and disposed adjacent to the through hole 3121 in the lower end 312 of the lower leg rod 31, and is connected pivotally to the lower end 312 of the lower leg rod 31 (see FIGS. 4 and 5) using a bolt 351, which extends through the pivot lugs 331 and the through hole 3121 in the lower end 312 of the lower leg rod 31, and a nut 352 engaging the bolt 351. The upper leg rod 32 of each telescopic leg unit 3 is sleeved movably on the lower leg rod 31, has an upper end 321 formed with a through hole 322, and is formed with a vertical slot 320 therethrough. For each telescopic leg unit 3, the first positioning member 34 extends through the lower leg rod 31, is slidable on the upper leg rod 32 along the vertical slot 320, and is operable so as to anchor the upper leg rod 32 to the lower leg rod 31. In this embodiment, for each telescopic leg unit 3, the first positioning member 34 has a bolt 341 extending through the vertical slot 320 in the upper leg rod 32 and the through hole 3111 in the upper end 311 of the lower leg rod 31, and slidable along the vertical slot 320 in the upper leg rod 32, and a nut 342 engaging the bolt 341. For each telescopic leg unit 3, to anchor the upper leg rod 32 to the lower leg rod 31, the nut 342 is tightened to clamp the upper leg rod 32 between the bolt 341 and the nut 342.

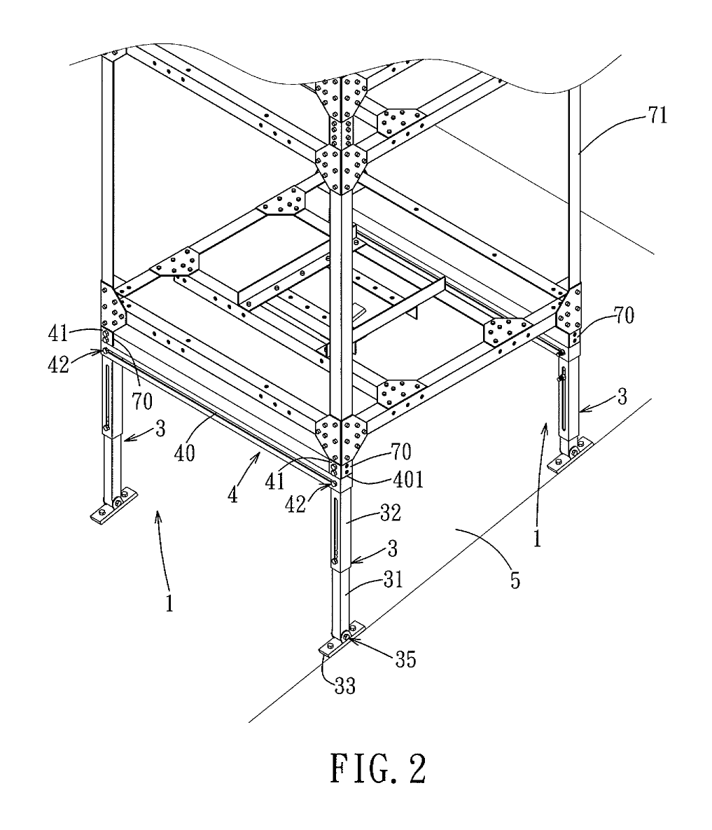

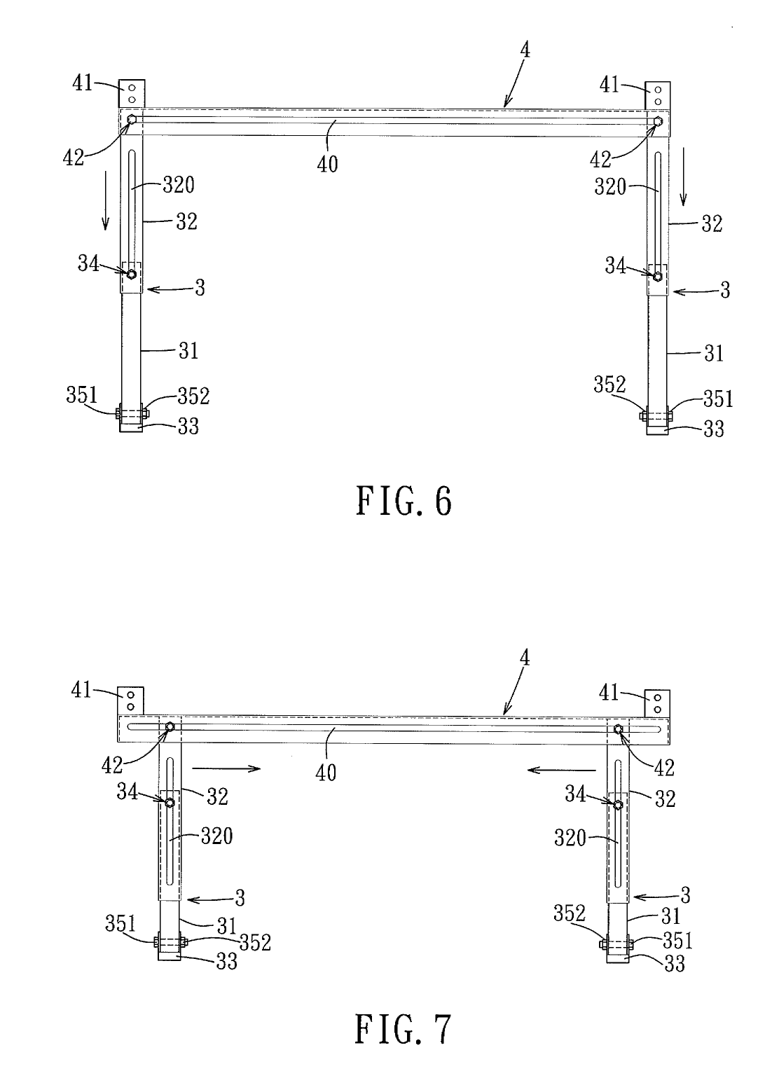

For each supporting device 1, the connecting seat 4 is mounted on the upper ends 321 of the upper leg rods 32 of the telescopic leg units 3 such that each telescopic leg unit 3 is movable relative to the connecting seat 4 in a direction perpendicular to the telescopic leg units 3 (see FIGS. 6 and 7), and is formed with a horizontal slot 40 therethrough. In this embodiment, the connecting seat 4 of each supporting device 1 has opposite connecting extensions 41 adapted to be connected fixedly to two corresponding ones of the angle bars 70 of the main frame 71, as shown in FIG. 2.

For each supporting device 1, the positioning unit includes a pair of second positioning members 42 each extending through the upper end 321 of the upper leg rod 32 of a corresponding telescopic leg unit 3 and the horizontal slot 40 in the connecting seat 4 such that the second positioning member 42 are slidable along the horizontal slot 40 in the connecting seat 4. The second positioning members 42 are operable in a manner similar to that of the first positioning members 34 so as to anchor the telescopic leg units 3 to the connecting seat 4 such that a desired distance is formed between the telescopic leg units 3. In this embodiment, for each supporting device 1, each second positioning member 42 of the positioning unit has a bolt 421 extending through the horizontal slot 40 in the connecting seat 4 and the through hole 322 in the upper end 321 of the upper leg rod 32 of the corresponding telescopic leg unit 3, and a nut 422 engaging the bolt 421.

In use, since the mounting plates 33 of the telescopic leg units 3 are pivotable to abut against an outer surface of the gable roof 5 (see FIG. 2), and since each telescopic leg unit 3 is adjustable to have a desired length in a vertical direction, by using the assembly of the supporting devices 1 of this invention, the electric generating apparatus 7 can be supported stably and directly above an inclined surface of the gable roof 5.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A supporting device comprising:
a pair of telescopic leg units each including
a vertical lower leg rod having opposite upper and lower ends,
a mounting plate connected pivotally to said lower end of said lower leg rod and adapted to be mounted on a supporting surface,
a vertical upper leg rod sleeved movably on said lower leg rod and having an upper end, and
a first positioning member extending through one of said upper and lower leg rods and slidable on the other one of said upper and lower leg rods, said first positioning member being operable so as to anchor said upper leg rod to said lower leg rod;
a hollow connecting seat adapted to be attached fixedly to an object to be supported and mounted on said upper ends of said upper leg rods of said telescopic leg units such that each of said telescopic leg units is movable relative to said connecting seat in a direction perpendicular to said telescopic leg units, said connecting seat being formed with a horizontal slot therethrough; and
a pair of second positioning members each extending through said upper end of said upper leg rod of a corresponding one of said telescopic leg units and said horizontal slot in said connecting seat such that said second positioning members are slidable along said horizontal slot in said connecting seat, said second positioning members being operable so as to anchor said telescopic leg units to said connecting seat such that a desired distance is formed between said telescopic leg units.

2. The supporting device as claimed in claim 1, wherein:
said upper leg rod of each of said telescopic leg units is formed with a vertical slot therethrough;
said first positioning member of each of said telescopic leg units has a bolt extending through said vertical slot in said upper leg rod of a corresponding one of said telescopic leg units, and a nut engaging said bolt; and
said lower leg rod of each of said telescopic leg units is formed with a through hole to permit extension of said bolt of said first positioning member of a corresponding one of said telescopic leg units therethrough.

3. The support device as claimed in claim 1, wherein:
said upper end of said upper leg rod of each of said telescopic leg units is formed with a through hole; and
each of said second positioning members has a bolt extending through said horizontal slot in said connecting seat and said through hole in said upper end of said upper leg rod of the corresponding one of said telescopic leg units, and a nut engaging said bolt.
